(19) United States
(12) Patent Application Publication
(10) Pub. No.: US 2026/0148436 A1
(43) Pub. Date: May 28, 2026

(54) METHOD, DEVICE AND STORAGE MEDIUM FOR CONTENT GENERATION

(71) Applicants: Lemon Inc., Grand Cayman (KY); Beijing Zitiao Network Technology Co., Ltd., Beijing (CN)

(72) Inventors: Chaorui DENG, Los Angeles, CA (US); Deyao ZHU, Los Angeles, CA (US); Kunchang LI, Beijing (CN); Haoqi FAN, Los Angeles, CA (US)

(21) Appl. No.: 19/397,721

(22) Filed: Nov. 21, 2025

(30) Foreign Application Priority Data
Nov. 22, 2024 (CN) 202411686223.8

(51) Int. Cl. G06T 11/00; G06T 5/60; G06T 5/70

(52) U.S. Cl. CPC G06T 11/00; G06T 5/60; G06T 5/70; G06T 2207/20081; G06T 2207/20084

(57) ABSTRACT

According to embodiments of the disclosure, a method, apparatus, device and storage medium for content generation are provided. The method includes: constructing an input sequence of a target model based on receiving a content generation request; processing the input sequence with the target model to generate a hidden feature corresponding to at least one content token, wherein the number of the at least one content token is associated with an output modality of the content generation request; and providing the hidden feature to a target output layer corresponding to the output modality among a plurality of output layers of the target model, to generate target content corresponding to the at least one content token.

### CROSS-REFERENCE

This application claims the benefit of Chinese Patent Application No. 202411686223.8, filed on Nov. 22, 2024, entitled “METHOD, APPARATUS, DEVICE AND STORAGE MEDIUM FOR CONTENT GENERATION,” the entire content of which is incorporated herein by reference.

### FIELD

Example embodiments of the present disclosure generally relate to the field of computers, and in particular, to a method, apparatus, device and computer-readable storage medium for content generation.

### BACKGROUND

With the advancement of deep learning technology, generative models have demonstrated significant capabilities in processing and generating multimodal data. Multimodal data processing refers to the simultaneous processing and analysis of information from various data sources, such as text, images, sounds, and other types of data from different modalities. This technology has a wide range of applications across multiple fields, including but not limited to natural language processing, computer vision, speech recognition, and multimedia content generation.

### SUMMARY

In a first aspect of the present disclosure, a method of content generation is provided. The method includes: constructing an input sequence of a target model based on receiving a content generation request; processing the input sequence with the target model to generate a hidden feature corresponding to at least one content token, where the number of the at least one content token is associated with an output modality of the content generation request; and providing the hidden feature to a target output layer corresponding to the output modality among a plurality of output layers of the target model, to generate target content corresponding to the at least one content token.

In a second aspect of the present disclosure, an apparatus for content generation is provided. The apparatus includes a constructing module configured to construct an input sequence of a target model based on receiving a content generation request; a processing module configured to process the input sequence with the target model to generate a hidden feature corresponding to at least one content token, where the number of the at least one content token is associated with an output modality of the content generation request; and a generating module configured to provide the hidden feature to a target output layer corresponding to the output modality among a plurality of output layers of the target model, to generate target content corresponding to the at least one content token.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium has a computer program stored thereon, the computer program, when executed by a processor, implementing the method of the first aspect.

It should be understood that the content described in this content section is not intended to limit the key features or important features of embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates an example model architecture according to some embodiments of the present disclosure;

FIG. 2 illustrates a flowchart of an example process for content generation according to some embodiments of the present disclosure;

FIG. 3 illustrates a schematic diagram of generating an image according to some embodiments of the present disclosure;

FIG. 4 illustrates a block diagram of an apparatus for content generation according to some embodiments of the present disclosure; and

FIG. 5 illustrates a block diagram of an electronic device capable of implementing various embodiments of the present disclosure.

### DETAILED DESCRIPTION

It would be appreciated that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to obtain and use the personal information of the user. Therefore, it enables users to autonomously select whether to provide personal information to electronic devices, applications, servers, or storage media that implement the present technical solution, based on the prompt information.

As an optional but non-limiting implementation, in response to receiving the active request of the user, the manner of sending the prompt information to the user may be, for example, a pop-up window, and the pop-up window may present the prompt information in a text manner. In addition, the pop-up window may further carry a selection control for the user to select “agree” or “disagree” to provide personal information to the electronic device.

It would be appreciated that the foregoing notification and the process of obtaining user authorization are merely illustrative, and do not constitute a limitation on the implementation of the present disclosure. Other methods that comply with relevant laws and regulations can also be applied to the implementation of the present disclosure.

It would be appreciated that the data involved in the technical solution (including but not limited to the data itself, the obtaining or use of the data) should follow the requirements of the corresponding laws and regulations and related regulations.

The term “in response to” used herein indicates the state where the corresponding event occurs or the condition is met. It will be understood that the execution timing of the subsequent action executed in response to the event or condition is not necessarily strongly correlated with the time when the event occurs or the condition is established. For example, in some cases, the subsequent action may be executed immediately when the event occurs or the condition is met; while in other cases, the subsequent action may be executed after a period of time following the occurrence of the event or the establishment of the condition.

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’, and the like should be understood to include ‘including but not limited to’. The term ‘based on’ should be understood as ‘based at least in part on’. The terms ‘one embodiment’ or ‘the embodiment’ should be understood as ‘at least one embodiment’. The term ‘some embodiments’ should be understood as ‘at least some embodiments’. Other explicit and implicit definitions may also be included below.

Multi-modality data processing involves comprehensive analysis and processing of data, such as text, images, sounds, etc., from different sources and forms. Conventional multimodal processing techniques rely primarily on integration of independent models, which are typically optimized for particular data modalities.

Traditional solutions often lack effective cross-modal information fusion mechanisms, leading to inability to adequately capture and utilize interrelated and complementary information between different modalities. In addition, conventional solutions generally need to design and train specialized models for different modalities, increasing system complexity and resource consumption.

For this purpose, embodiments of the present disclosure provide a solution for content generation. According to various embodiments of the present disclosure, an input sequence of a target model may be constructed based on receiving a content generation request. Further, the input sequence may be processed with the target model to generate a hidden feature corresponding to at least one content token, where the number of the at least one content token is associated with an output modality of the content generation request. Additionally, the hidden feature may be provided to a target output layer corresponding to the output modality among a plurality of output layers of the target model, to generate target content corresponding to the at least one content token.

Thus, the embodiments of the disclosure can support implementing an output of content of a plurality of modalities with a unified model architecture. Therefore, the embodiment of the present disclosure can reduce the complexity of the model and simplify the training and deployment process of the model.

Example embodiments of the present disclosure are described below with reference to the accompanying drawings.

### Example Model Architecture

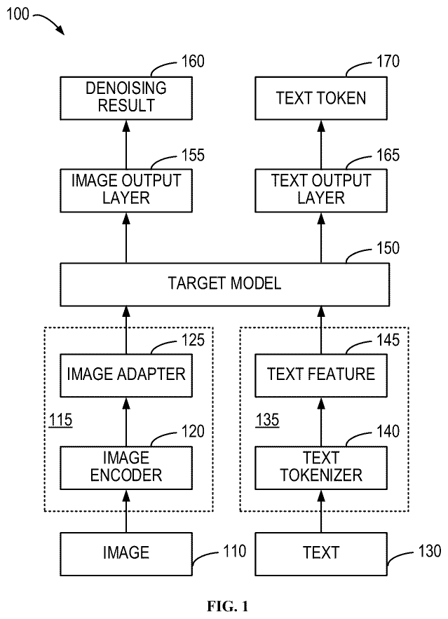

FIG. 1 illustrates an example architecture 100 of a model according to some embodiments of the present disclosure. As shown in FIG. 1, a target model 150 may have a plurality of encoding units, such as an encoding unit 115 and an encoding unit 135. The plurality of encoding units may be adapted to process data of different modalities, so that the target model can fuse input information of different modalities.

Taking FIG. 1 as an example, the encoding unit 115 may include an image encoder 120 and an image adapter 125. The image encoder 120 may encode the image 110 and may map, by the image adapter 125, the encoded representation of the image 110 to a dimension suitable for processing by the target model 150.

The encoding unit 135 may include a text tokenizer, which may, for example, split a text 130 into a plurality of tokens, and may accordingly generate a corresponding text feature 145 to provide to the target model 150.

In some embodiments, the target model 150 may further be associated with an additional encoding unit corresponding to a further appropriate modality, for example, an encoding unit for processing audio data. Such additional encoding units can encode data of a further modalities to transform the data into features suitable for input to the target model 150.

In addition, as shown in FIG. 1, the target model 150 may further be associated with a plurality of output layers (also referred to as output heads). For example, an image output layer 155 and a text output layer 165. Such the plurality of output layers may be used to decode a hidden feature output by the target model 150 into data of corresponding modality.

In some embodiments, the target model 150 may further be associated with an additional output layer corresponding to a further appropriate modality. For example, an output layer corresponding to the audio data. Such output layer can, for example, decode the hidden feature generated by the target model into audio content.

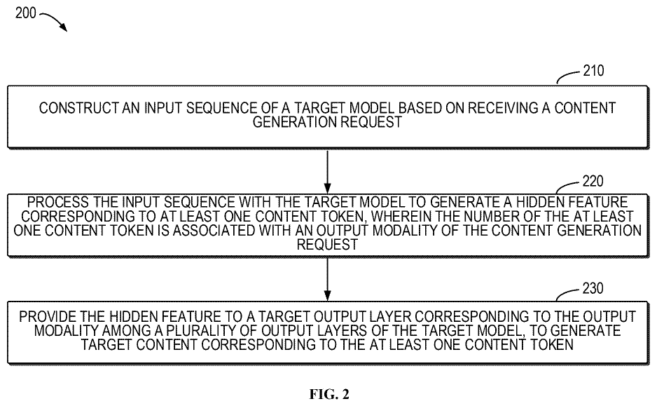

Therefore, the target model 150 may support a specific process of processing the multimodal task by using the target model 150 in detail with reference to FIG. 2.

### Example Processes

FIG. 2 illustrates a flowchart of an example process 200 of information processing according to some embodiments of the present disclosure. The process 200 may be implemented at an appropriate electronic device deploying a model as discussed in FIG. 1. The process 200 is described below with reference to FIG. 1.

At block 210, the electronic device constructs an input sequence of a target model based on receiving a content generation request.

As discussed with reference to FIG. 1, the target model 150 may include a plurality of encoding units corresponding to different input modalities. Further, the electronic device may obtain condition information associated with the content generation request.

In some embodiments, the condition information may include content of one or more modalities, such as text content, image content, audio content, video content, and the like. As an example, the condition information may include a prompt text input by the user.

Further, the electronic device may determine, based on an input modality of the condition information, at least one encoding unit matching the input modality from the plurality of encoding units. Further, the electronic device may process the condition information with the at least one encoding unit to generate at least a portion of an input sequence.

As an example, if the condition information includes text content, the electronic device may process the text content with the encoding unit 135 to generate a sequence portion corresponding to the text content. For example, in a text-to-image scenario, the electronic device 110 can process the input text content with the encoding unit 135 to generate a corresponding feature sequence.

As a further example, if the condition information includes image content, the electronic device may process the image content with the encoding unit 115 to generate a sequence portion corresponding to the image content. For example, in an image-to-text scenario, the electronic device 110 may process the input image content with the encoding unit 115 to generate a corresponding feature sequence.

At block 220, the electronic device processes the input sequence with the target model to generate a hidden feature corresponding to at least one content token, where the number of the at least one content token is associated with an output modality of the content generation request.

In some embodiments, if the output modality corresponding to the content generation request includes text, the electronic device may process the input sequence with the target model to generate the hidden feature corresponding to a single text token. Similar to the processing process of the language model, the electronic device may generate, with the target model, the hidden feature corresponding to a next text token.

In some embodiments, if the output modality corresponding to the content generation request includes an image, the electronic device may process the input sequence with the target model to generate a hidden feature corresponding to the set of noise tokens, where the number of the set of noise tokens is less than a total number of image patches in the target image to be generated.

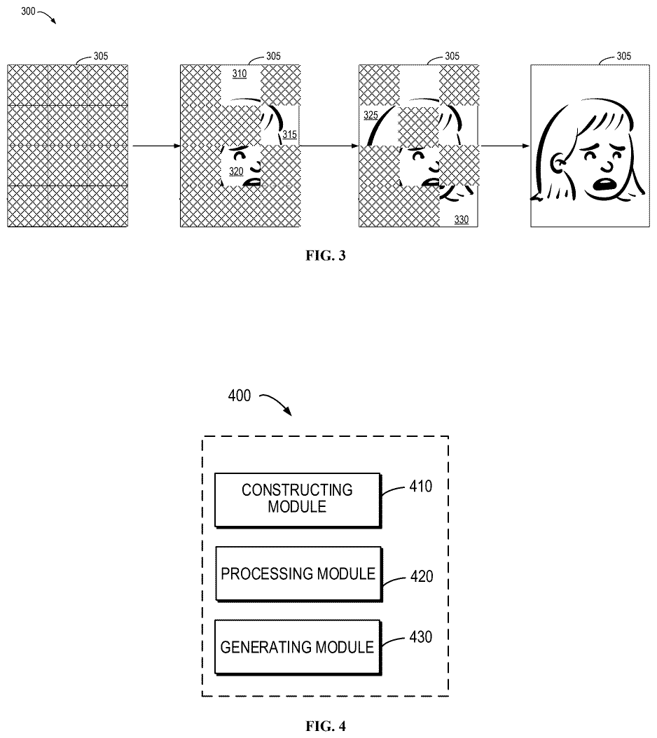

The specific process of the image generation task will be further described below with reference to FIG. 3. FIG. 3 illustrates several stages of generating a target image 305.

In some embodiments, the electronic device may first partition the target image 305 to be generated into a plurality of image patches. In some embodiments, a size of each image patch may be a fixed size or a random size. Alternatively, a total number of image patches in the target image 305 may be, for example, a preset number or a random number. Taking FIG. 3 as an example, the target image 305 may be partitioned into 12 image patches, for example.

Further, the electronic device 110 may generate, based on the condition information, a hidden feature corresponding to one or more image patches in the target image 305. As an example, the target model may perform an autoregressive process to generate a hidden feature. As will be described below, these hidden features may be used to construct noise data used to generate one or more image patches.

Taking FIG. 3 as an example, the electronic device may, for example, execute a three-wheel autoregressive process and generate hidden features corresponding to three image patches (i.e., image patch 310, image patch 315, and image patch 320).

Thus, in a text generation scenario, the target model may output a hidden feature corresponding to the single text token. In an image generation scenario, the target model not only supports outputting a hidden feature corresponding to a single noise token but also supports outputting a hidden feature corresponding to a plurality of noise tokens. Thus, the number of at least one content token corresponding to the hidden feature output by the target model is associated with an output modality of the content generation request.

With continued reference to FIG. 2, at block 230, the electronic device provides the hidden feature to a target output layer corresponding to the output modality among a plurality of output layers of the target model, to generate target content corresponding to the at least one content token.

In some embodiments, for the text generation task, as shown in FIG. 1, the electronic device 110 may provide the generated hidden feature to the text output layer 165, to obtain a next text token 170, thereby completing the generation of the text content.

In some embodiments, for an image generation task, the electronic device may provide the generated hidden feature to the image generation layer 155. Accordingly, the image output layer 155 may determine, based on the hidden feature, noise data corresponding to the at least one noise token.

Continuing with FIG. 3 as an example, after generating the hidden features corresponding to the three image patches (i.e., the image patch 310, the image patch 315, and the image patch 320), the image output layer may decode the hidden feature into noise data corresponding to the three image patches.

Further, the electronic device may further denoise the noise data with a diffusion model to generate at least one image patch in the target image. As shown in FIG. 3, the diffusion model may denoise the noise data corresponding to respective image patch, so as to restore the corresponding denoising result 160. Accordingly, the electronic device may generate image content of the image patch 310, the image patch 315, and the image patch 320.

In some embodiments, the number of image patches (i.e., the number of noise tokens) generated during each round of generation may be a preset number or a random number. Taking FIG. 3 as an example, the electronic device may first randomly generate 1 to 12 image patches in the 12 image patches.

In some embodiments, after the generation of the image patch 310, the image patch 315, and the image patch 320 is completed by using the diffusion model, the electronic device may perform a next round of autoregressive process to generate one or more image patches not yet generated in the target image 305.

Specifically, the electronic device may construct a new input sequence based on the image features of the generated image patch 310, the image patch 315, and the image patch 320. The target model may output the input sequence to generate noise data corresponding to other ungenerated image patches. As an example, the input sequence may include image tokens corresponding to the image patch 310, the image patch 315, and the image patch 320.

Taking FIG. 3 as an example, the target model may generate hidden features corresponding to an image patch 325 and an image patch 330 based on the condition information and the image tokens corresponding to the image patch 310, the image patch 315, and the image patch 320.

Further, the image output layer 155 may convert the hidden feature into noise data corresponding to the image patch 325 and the image patch 330, and may denoise the noise data with a diffusion model, to generate image content of the image patch 325 and the image patch 330.

Therefore, when generating the subsequent image content, the target model may consider features of the generated part in the image, thereby improving quality of image generation. In some embodiments, the target model may also ensure that only a feature of the generated image patch can be accessed when generating a token for the current image patch through a masking mechanism.

Thus, the generation process described above may be expressed as:

$$q ( {x}_{0 : T , {k}_{s}} \vert {x}_{0 : {k}_{1 : s - 1}} ) = q ( {x}_{0 : {k}_{s}} ) {\prod }_{t = 1}^{T} q ( {x}_{t : {k}_{s}} \vert {x}_{t - 1 : {k}_{s}} , {x}_{0 : {k}_{1 : s - 1}} ) \qquad ( 1 )$$

where

$$q ( {x}_{0 : T , {k}_{s}} \vert {x}_{0 : {k}_{1 : s - 1}} )$$

represents a clean image token

$${x}_{0 : {k}_{1 : s - 1}}$$

for a given previous step, the joint distribution of image tokens from the noise image to the T-th step diffusion process is obtained. q(x_{0,κ}_{ₛ}) represents an initial distribution of image tokens at the s-th step autoregressive step.

$$q ( {x}_{t : {k}_{s}} \vert {x}_{t - 1 : {k}_{s}} , {x}_{0 : {k}_{1 : s - 1}} )$$

is a distribution of image tokens at the t-th step diffusion process, given the image token x_{t-1,κ}_{ₛ} from the previous diffusion step and the clean image

$${x}_{0 : {k}_{1 : s - 1}}$$

for all previous autoregressive steps. S represents the total number of steps from autoregression, κₛ represents an index of the subset of image tokens being processed at the S-th step autoregression, and |κₛ| represents the number of image tokens in the subset.

In this way, the embodiments of the present disclosure achieve a more refined and comprehensive modeling of data distribution through the sequential processing capability of the autoregressive model and the iterative denoising capability of the diffusion model. This dual modeling strategy enhances the quality and diversity of data generation. Furthermore, by combining the AR and diffusion models, the embodiments of the present disclosure allow for finer control over the generation process, including the generation order and detail levels. This flexibility enables the model to adapt to various complex multimodal generation tasks.

On the other hand, the embodiments of the present disclosure utilize the deterministic generation of the autoregressive model and the probabilistic iteration of the diffusion model to improve generation efficiency. Compared to using a diffusion model alone, the embodiments of the present disclosure reduce the number of iterations required, thereby accelerating the generation speed.

In addition, the model incorporates the characteristics of an autoregressive model, which means that during the image generation process, the generation of each part depends on the previously generated parts. This dependency allows the model to infer and generate missing or edited parts based on the existing contextual information without additional samples, thereby achieving zero-shot image editing. As an example, the electronic device can replace the content in a specific area of a reference image from a first object (for example, a flower) with a second object (for example, an animal) based on the user's editing request.

The embodiments of the present disclosure can also support collaborative processing of multimodal output task, so that the model can complete generation of image content and text content, for example. Taking the output relating to the image modality and the text modality as an example, the electronic device may first complete, using the processes described above, generation of the target content corresponding to the first output modality.

Further, the target model may further process a generation task corresponding to the second output modality. Specifically, unlike constructing the feature sequence for generating the target content, the electronic device may construct a second input sequence of the target model based on the generated target content. Further, similar to the process described above, the electronic device may process the second input sequence with the target model, causing an additional output layer of the plurality of output layers corresponding to the second output modality generates additional content corresponding to the second output modality.

As an example, a content generation request can instruct the model to generate an image and corresponding descriptive text based on an input text. Accordingly, the electronic device may construct the first input sequence based on the text, and may iteratively generate the corresponding image in combination with the autoregressive step and the diffusion step. Further, the electronic device may further construct a second input sequence based on the image token of the generated image to predict the next text token through an output token-by-token manner, thereby completing the generation of the text content.

### Example Apparatus and Device

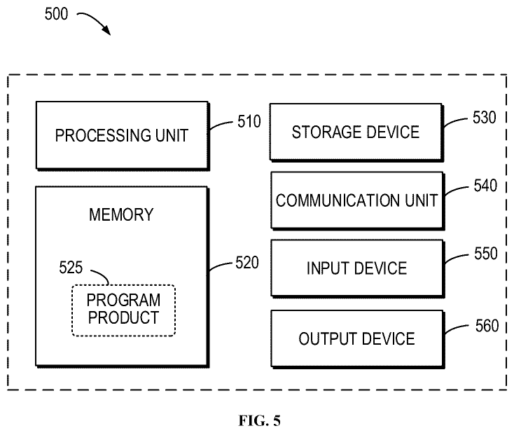

The embodiments of the present disclosure also provide a corresponding apparatus for implementing the above method or process. FIG. 4 is a schematic structural block diagram of an apparatus 400 for training an image generation model according to some embodiments of the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes: a constructing module 410 configured to construct an input sequence of a target model based on receiving a content generation request; a processing module 420 configured to process the input sequence with the target model to generate a hidden feature corresponding to at least one content token, where the number of the at least one content token is associated with an output modality of the content generation request and a generating module 430 configured to provide the hidden feature to a target output layer corresponding to the output modality among a plurality of output layers of the target model, to generate target content corresponding to the at least one content token.

In some embodiments, the target model includes a plurality of encoding units corresponding to different input modalities, and the constructing module 410 is further configured to: obtain condition information associated with the content generation request; determine, based on an input modality of the condition information, at least one encoding unit matching the input modality from the plurality of encoding units; and process the condition information with the at least one encoding unit to generate at least a portion of the input sequence.

In some embodiments, the processing module 420 is further configured to: process, in response to the output modality including an image, the input sequence with the target model to generate the hidden feature corresponding to a set of noise tokens, the number of the set of noise tokens being less than the total number of image patches in a target image to be generated.

In some embodiments, the generating module 430 is further configured to: determine, with the target output layer and based on the hidden feature, noise data corresponding to the at least one noise token; and denoise the noise data with a diffusion model to generate at least one image patch in the target image.

In some embodiments, the input sequence further includes an image feature corresponding to the at least one generated image patch in the target image.

In some embodiments, the apparatus 400 further includes a partitioning module configured to partition the input sequence further includes an image feature corresponding to the at least one generated image patch in the target image.

In some embodiments, the number of the set of noise tokens is a preset number or a random number.

In some embodiments, the processing module 420 is further configured to: proc, in response to the output modality including text, the input sequence with the target model to generate the hidden feature corresponding to a single text token.

In some embodiments, the output modality is a first output modality, the input sequence is a first input sequence, and the apparatus 400 is further configured to: construct, based on the target content, a second input sequence of the target model in response to the content generation request being further associated with a second output modality; and process the second input sequence with the target model, to cause an additional output layer, among the plurality of output layers, corresponding to the second output modality generates additional content corresponding to the second output modality.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in the apparatus 400 may be at least partially implemented by one or more hardware logic components. As examples, not limitations, example types of hardware logic components that may be used include Field-Programmable Gate Arrays (FPGA), Application-Specific Integrated Circuits (ASIC), Application-Specific Standard Products (ASSP), System on Chip (SOC), Complex Programmable Logic Devices (CPLD), and so on.

FIG. 5 illustrates a block diagram of an electronic device 500 in which one or more embodiments of the present disclosure may be implemented. It should be understood that the electronic device 500 illustrated in FIG. 5 is merely for example and should not constitute any limitation on the function and scope of the embodiments described herein. The electronic device 500 shown in FIG. 5 may be configured to implement the image generation system 100 described above.

As shown in FIG. 5, the electronic device 500 is in a form of a general-purpose electronic device. Components of the electronic device 500 may include, but are not limited to, one or more processors or processing units 510, memory 520, storage device 530, one or more communication units 540, one or more input devices 550, and one or more output devices 560. The processing units 510 may be actual or virtual processors and are capable of performing various processes based on programs stored in the memory 520. In a multiprocessor system, a plurality of processors perform computer-executable instructions in parallel to increase the parallel processing power of the electronic device 500.

The electronic device 500 typically includes a plurality of computer storage media. Such media may be any obtainable media accessible to the electronic device 500, including, but not limited to, volatile and non-volatile media, removable and non-removable media. The memory 520 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, a disk, or any other medium that may be capable of being used to store information and/or data and may be accessible within the electronic device 500.

The electronic device 500 may further include additional removable/non-removable, volatile/non-volatile storage media. Although not shown in FIG. 5, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 520 may include a computer program product 525 having one or more program modules that are configured to perform various methods or actions of various embodiments of the present disclosure.

The communication unit 540 implements communication with other electronic devices via a communication medium. Additionally, the functions of the components of the electronic device 500 may be implemented as a single computing cluster or a plurality of computing machines that are capable of communicating over a communication connection. Thus, the electronic device 500 may use logical connections to one or more other servers, networked personal computers (PCs), or a further network node to operate in a networked environment.

The input device 550 may be one or more input devices, such as a mouse, a keyboard, a tracking ball, and the like. The output device 560 may be one or more output devices, such as a monitor, a speaker, a printer, and the like. The electronic device 500 may also communicate, as desired, via the communication unit 540, with one or more external devices (not shown), external devices such as storage devices, display devices, etc., with one or more devices that enable a user to interact with the electronic device 500, or with any device that enables the electronic device 500 to communicate with one or more other electronic devices (e.g., a network card, modem, etc.) to communicate. Such communication may be performed via an input/output (I/O) interface (not shown).

According to example implementations of the present disclosure, a computer-readable storage medium having a computer program stored thereon is provided, the program, when performed by a processor, implementing the method described above. According to example implementations of the present disclosure, a computer program product is also provided, the computer program product being tangibly stored on a non-transitory computer-readable medium and including computer-executable instructions, and the computer-executable instructions being performed by a processor to implement the methods described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of content generation, comprising:
constructing an input sequence of a target model based on receiving a content generation request;
processing the input sequence with the target model to generate a hidden feature corresponding to at least one content token, wherein the number of the at least one content token is associated with an output modality of the content generation request; and
providing the hidden feature to a target output layer corresponding to the output modality among a plurality of output layers of the target model, to generate target content corresponding to the at least one content token.

2. The method of claim 1, wherein the target model comprises a plurality of encoding units corresponding to different input modalities, and constructing the input sequence of the target model based on receiving the content generation request comprises:
obtaining condition information associated with the content generation request;
determining, based on an input modality of the condition information, at least one encoding unit matching the input modality from the plurality of encoding units; and
processing the condition information with the at least one encoding unit to generate at least a portion of the input sequence.

3. The method of claim 1, wherein processing the input sequence with the target model to generate the hidden feature corresponding to the at least one content token comprises:
processing, in response to the output modality comprising an image, the input sequence with the target model to generate the hidden feature corresponding to a set of noise tokens, the number of the set of noise tokens being less than the total number of image patches in a target image to be generated.

4. The method of claim 3, wherein providing the hidden feature to the target output layer corresponding to the output modality among the plurality of output layers of the target model to generate the target content corresponding to the at least one content token comprises:
determining, with the target output layer and based on the hidden feature, noise data corresponding to the at least one noise token; and
denoising the noise data with a diffusion model to generate at least one image patch in the target image.

5. The method of claim 3, wherein the input sequence further comprises an image feature corresponding to the at least one generated image patch in the target image.

6. The method of claim 3, further comprising:
partitioning the target image to be generated into a plurality of image patches, wherein a size of each image patch and/or a total number of the plurality of image patches is determined randomly.

7. The method of claim 3, wherein the number of the set of noise tokens is a preset number or a random number.

8. The method of claim 1, wherein processing the input sequence with the target model to generate the hidden feature corresponding to the at least one content token comprises:
processing, in response to the output modality comprising text, the input sequence with the target model to generate the hidden feature corresponding to a single text token.

9. The method of claim 1, wherein the output modality is a first output modality, the input sequence is a first input sequence, and the method further comprises:
constructing, based on the target content, a second input sequence of the target model in response to the content generation request being further associated with a second output modality; and
processing the second input sequence with the target model, to cause an additional output layer, among the plurality of output layers, corresponding to the second output modality generates additional content corresponding to the second output modality.

10. An electronic device, comprising:
at least one processor; and
at least one memory coupled to the at least one processor and storing instructions for execution by the at least one processor, the instructions, when executed by the at least one processor, causing the electronic device to perform operations comprising:
constructing an input sequence of a target model based on receiving a content generation request;
processing the input sequence with the target model to generate a hidden feature corresponding to at least one content token, wherein the number of the at least one content token is associated with an output modality of the content generation request; and
providing the hidden feature to a target output layer corresponding to the output modality among a plurality of output layers of the target model, to generate target content corresponding to the at least one content token.

11. The electronic device of claim 10, wherein the target model comprises a plurality of encoding units corresponding to different input modalities, and constructing the input sequence of the target model based on receiving the content generation request comprises:
obtaining condition information associated with the content generation request;
determining, based on an input modality of the condition information, at least one encoding unit matching the input modality from the plurality of encoding units; and
processing the condition information with the at least one encoding unit to generate at least a portion of the input sequence.

12. The electronic device of claim 10, wherein processing the input sequence with the target model to generate the hidden feature corresponding to the at least one content token comprises:
processing, in response to the output modality comprising an image, the input sequence with the target model to generate the hidden feature corresponding to a set of noise tokens, the number of the set of noise tokens being less than the total number of image patches in a target image to be generated.

13. The electronic device of claim 12, wherein providing the hidden feature to the target output layer corresponding to the output modality among the plurality of output layers of the target model to generate the target content corresponding to the at least one content token comprises:
determining, with the target output layer and based on the hidden feature, noise data corresponding to the at least one noise token; and
denoising the noise data with a diffusion model to generate at least one image patch in the target image.

14. The electronic device of claim 12, wherein the input sequence further comprises an image feature corresponding to the at least one generated image patch in the target image.

15. The electronic device of claim 12, wherein the operations further comprise:
partitioning the target image to be generated into a plurality of image patches, wherein a size of each image patch and/or a total number of the plurality of image patches is determined randomly.

16. The electronic device of claim 12, wherein the number of the set of noise tokens is a preset number or a random number.

17. The electronic device of claim 10, wherein processing the input sequence with the target model to generate the hidden feature corresponding to the at least one content token comprises:
processing, in response to the output modality comprising text, the input sequence with the target model to generate the hidden feature corresponding to a single text token.

18. The electronic device of claim 10, wherein the output modality is a first output modality, the input sequence is a first input sequence, and the operations further comprise:
constructing, based on the target content, a second input sequence of the target model in response to the content generation request being further associated with a second output modality; and
processing the second input sequence with the target model, to cause an additional output layer, among the plurality of output layers, corresponding to the second output modality generates additional content corresponding to the second output modality.

19. A non-transitory computer-readable storage medium having a computer program stored thereon, the computer program, when executed by a processor, implementing operations comprising:
constructing an input sequence of a target model based on receiving a content generation request;
processing the input sequence with the target model to generate a hidden feature corresponding to at least one content token, wherein the number of the at least one content token is associated with an output modality of the content generation request; and
providing the hidden feature to a target output layer corresponding to the output modality among a plurality of output layers of the target model, to generate target content corresponding to the at least one content token.

20. The non-transitory computer-readable storage medium of claim 19, wherein the target model comprises a plurality of encoding units corresponding to different input modalities, and constructing the input sequence of the target model based on receiving the content generation request comprises:
obtaining condition information associated with the content generation request;
determining, based on an input modality of the condition information, at least one encoding unit matching the input modality from the plurality of encoding units; and
processing the condition information with the at least one encoding unit to generate at least a portion of the input sequence.
